(19) United States
(12) Patent Application Publication
(10) Pub. No.: US 2011/0246069 A1
(43) Pub. Date: Oct. 6, 2011

(54) Method for determining the trajectory of a ballistic missile

(75) Inventors: Alain PERES, Fontenay (FR); Frédéric Perrin, Sevres (FR); Eric Sauty, Paris (FR)

(73) Assignee: THALES, Neuilly-sur-Seine (FR)

(21) Appl. No.: 13/015,956

(22) Filed: Jan. 28, 2011

(30) Foreign Application Priority Data
Jan. 29, 2010 (FR) 10 00371

(51) Int. Cl. G01C 21/00; G01C 21/20; G01C 21/24

(52) U.S. Cl. 701/226

(57) ABSTRACT

A method for determining the trajectory of a ballistic missile using elevation and azimuth angle measurements comprises a step for determining, at different instants when the ballistic missile is in unpropelled exoatmospheric phase, an azimuth angle and an elevation angle of the ballistic missile, and a step for determining positions in three dimensions of the ballistic missile at said instants from the various pairs of angles and from a kinematic non-braked ballistic trajectory model.

The invention relates to the field of the detection and trajectography of ballistic missiles. It relates to a method for determining the trajectory of a ballistic missile using elevation and azimuth angle measurements.

The trajectography of a ballistic missile is generally produced either directly from sets of measurements in three dimensions obtained from a single sensor, or by triangulation using measurements in two dimensions obtained from at least two sensors located at two distinct points.

The measurements in three dimensions are, for example, fixed in a spherical coordinate system centred on the sensor. They then comprise two angular measurements, namely an azimuth angle measurement and an elevation angle measurement, and a measurement of distance between the sensor and the ballistic missile. The distance may be measured using a radar or a laser range finder. The use of a radar would seem to be the most obvious solution in as much as the azimuth and elevation angle measurements can also be obtained by the radar. However, a ballistic missile has a weak radar signature and may be located at a distance that is relatively far from the radar, sometimes more than a thousand kilometres, the region to be monitored potentially being extensive. Consequently, the radar must be provided with specific radar processing functions and a large antenna to be able to detect a ballistic missile. These constraints obviously result in significant complexity and cost. An alternative solution to the radars consists in using a laser range finder to measure the distance to the ballistic missile, the azimuth and elevation angle measurements being, for example, obtained by a high-resolution camera. However, the laser range finders have a range that does not exceed 100 to 150 kilometres on ballistic missiles. This range is insufficient to cover extensive regions with dimensions measuring several hundreds of kilometres. Consequently, one difficulty associated with determining the trajectory of a ballistic missile from measurements in three dimensions is obtaining the distance measurement.

Trajectography by triangulation based on measurements in two dimensions requires at least two sensors located at distinct points whose positions are known. Each sensor, for example a high-resolution camera, supplies, at given instants, a pair of angles, namely an azimuth angle and an elevation angle. The position of a ballistic missile at a given instant in a coordinate system with three dimensions is then deduced from the corresponding two pairs of measurements and from the respective positions of the sensors. For the trajectography by triangulation to supply reliable positions, the two sensors must be sufficiently distant from one another and the trajectory of the ballistic missile must not be located in the vicinity of the region situated between the two sensors. At least three sensors are therefore in practice required to cover all of a region. The multiplicity of the sensors makes trajectography by triangulation complex and costly.

One aim of the invention is notably to mitigate all or some of the abovementioned drawbacks by making it possible to determine the three-dimensional trajectory of a ballistic missile in a simple, effective and economical manner. To this end, the subject of the invention is a method for determining the trajectory of a ballistic missile, characterized in that it comprises:

a step for determining, at different instants when the ballistic missile is in unpropelled exoatmospheric phase, an azimuth angle and an elevation angle of the ballistic missile,

a step for determining positions in three dimensions of the ballistic missile at said instants from the various pairs of angles and from a kinematic non-braked ballistic trajectory model.

One advantage of the invention is notably that it makes it possible to determine the three-dimensional trajectory of a ballistic missile from a single sensor giving only the angular positions of the ballistic missile.

According to a particular embodiment, the step for determining a pair of angles of the ballistic missile comprises a substep for determining a pair of coordinates of the ballistic missile that are representative of an azimuth angle and of an elevation angle of said ballistic missile, and a substep for determining the pair of angles of the ballistic missile from a relationship linking the pairs of coordinates to the pairs of angles of the ballistic missile.

The pairs of coordinates of the ballistic missile are, for example, acquired by a high-resolution camera, the coordinates of the ballistic missile being defined in a coordinate system linked to the high-resolution camera.

According to a particular embodiment, the step for determining positions in three dimensions of the ballistic missile is repeated on each determination of a new pair of angles, the positions in three dimensions of the ballistic missile being refined by the non-linear least squares method.

According to a first variant embodiment, the kinematic non-braked ballistic trajectory model takes into account a variable gravity as a function of the position of the ballistic missile relative to a terrestrial coordinate system.

According to a second variant embodiment, the step for determining positions in three dimensions of the ballistic missile comprises a first substep consisting in determining the positions in three dimensions using a kinematic non-braked ballistic trajectory model with constant gravity, and a second substep consisting in refining the positions in three dimensions using a kinematic non-braked ballistic trajectory model with variable gravity according to the position of the ballistic missile relative to a terrestrial coordinate system.

The method according to the invention may also include a step for estimating the point of impact of the ballistic missile from its positions in three dimensions in unpropelled exoatmospheric phase and from a kinematic braked ballistic trajectory model in atmospheric phase.

This step may comprise a preliminary step for determining the type of the ballistic missile from its trajectory in unpropelled exoatmospheric phase and from its range, the kinematic braked ballistic trajectory model using a ballistic coefficient that is a function of the type of the ballistic missile.

The method according to the invention may also comprise a step for estimating the launch point of the ballistic missile from its positions in three dimensions in unpropelled exoatmospheric phase and from a kinematic braked ballistic trajectory model in atmospheric phase.

The latter step may comprise a preliminary step for determining the type of the ballistic missile from its trajectory in unpropelled exoatmospheric phase and from its range, the kinematic braked ballistic trajectory model using a ballistic coefficient that is a function of the type of the ballistic missile.

It may also take account of pairs of angles of the ballistic missile determined before the unpropelled exoatmospheric phase.

The invention will be better understood and other advantages will become apparent from reading the following description, given with regard to the appended drawings which represent:

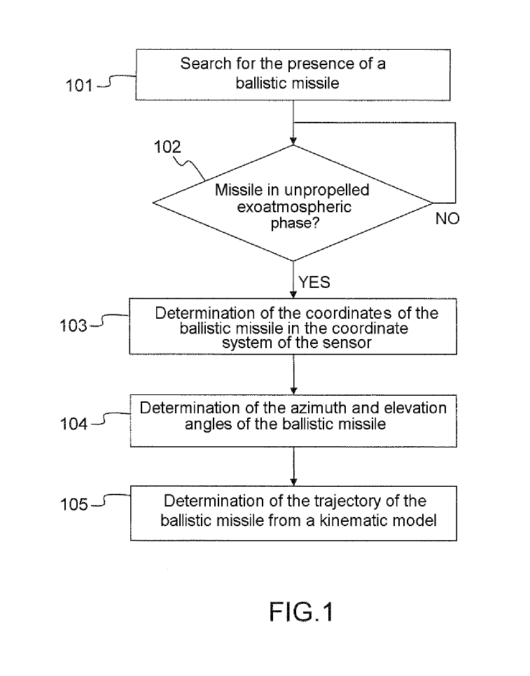

FIG. 1, an exemplary embodiment of the method of determining the trajectory of a ballistic projectile according to the invention;

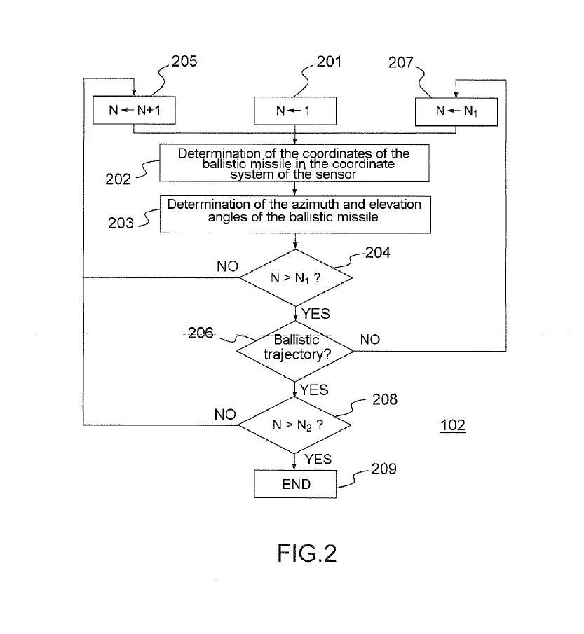

FIG. 2, an exemplary embodiment of a substep of the method of FIG. 1 consisting in checking that the ballistic missile has reached the unpropelled exoatmospheric flight phase.

The invention aims to determine the trajectory of ballistic missiles. A “ballistic missile” should be understood to be a self-propelled projectile describing a ballistic trajectory outside of the atmosphere after the propelled phase.

The method of determining the trajectory of a ballistic missile according to the invention uses azimuth angles and elevation angles defined in a spherical coordinate system. The azimuth or relative bearing angle is the projection in the horizontal plane of the angle formed between, on the one hand, the vertical plane passing through the origin of the spherical coordinate system and geographic north, and, on the other hand, the straight line passing through the origin and the object. An elevation angle of an object is defined as an angle between, on the one hand, a horizontal plane passing through the origin of the spherical coordinate system and, on the other hand, the straight line passing through the object and the origin. The azimuth and elevation angles can be measured directly in the spherical coordinate system, using a radar for example. However, in the context of the invention, the position of the objects, in this case of the ballistic missiles, is determined from a passive sensor such as a high-resolution camera, without knowing the distance to the object.

FIG. 1 represents an exemplary embodiment of the method according to the invention. In a first step 101, the presence of a ballistic missile may be sought in a region to be monitored. A ballistic missile is, for example, sought by the infrared radiation that it emits. When a ballistic missile has been detected, the flight phase that it is in is determined in a second step 102. At the very least, a determination is made as to whether the ballistic missile has reached the unpropelled exoatmospheric flight phase. In other words, a determination is made as to whether the ballistic missile has left the atmosphere and whether its propulsion is completed. This step 102 is, for example, performed by checking the infrared signature of the ballistic missile. If the level of the infrared radiation emitted by the ballistic missile drops abruptly, this means that the propulsion phase is ended. Generally, this propulsion phase ends once the ballistic missile has left the atmosphere. The check that the propulsion is completed is therefore sufficient to determine that the ballistic missile is in unpropelled exoatmospheric flight phase. The step 102 can also be performed by seeking to determine whether the ballistic missile is following a ballistic trajectory. This solution is detailed below with reference to FIG. 2. In a third step 103, angles αₜ and βₜ of the ballistic missile in a coordinate system linked to a high-resolution camera are determined, at various instants, called measurement instants t. This step 103 consists, for example, in identifying the pixel or pixels of the image from the camera that include a ballistic missile. The camera sensor is, for example, sensitive to the infrared wavelengths. Any other passive sensor may be used instead of a high-resolution camera, provided that it makes it possible to provide, at given instants, pairs of coordinates of an object that are representative of an azimuth angle and of an elevation angle of this object. In a fourth step 104, an azimuth angle θₜ and an elevation angle φₜ of the ballistic missile are determined, for each pair of angles (αₜ, βₜ) of the ballistic missile in the coordinate system of the camera. The azimuth θₜ and elevation φₜ angles are determined according to the orientation of the coordinate system of the camera relative to the spherical coordinate system concerned. In the case where the high-resolution camera is on board, the orientation is, for example, determined by an inertial unit or by a stellar observation system, the azimuth angle and the elevation angle being determined by interpolation between stars, the position of which is given by ephemerides.

A pair of angles (θₜ, φₜ), namely an azimuth angle θₜ and an elevation angle φₜ, is thus associated with each measurement instant t. According to a particular embodiment, the pairs of angles (θₜ, φₜ) can be determined directly, without involving pairs of angles (αₜ, βₜ). The steps 103 and 104 of the method described with reference to FIG. 1 are then replaced by a single step for determining pairs of angles (θₜ, φₜ.

The pairs of angles (θₜ, φₜ) constitute measurements of the angular motion of the ballistic missile as a function of time. Knowing only a number of pairs of angles does not however make it possible to deduce the associated distances dₜ to the ballistic missile and, consequently, to determine the positions in three dimensions of the ballistic missile. According to the invention, in a fifth step 105, the positions in three dimensions (dₜ, θₜ, φₜ) of the missile at the various measurement instants t are determined by associating the pairs of angles (θₜ, φₜ) with a kinematic non-braked ballistic trajectory model. The positions in three dimensions of the missile are considered in a spherical coordinate system. They could, however, equally be considered in a Cartesian coordinate system. The kinematic model considers a ballistic trajectory that is dependent only on the force of gravity. This is because, since the ballistic missile has left the atmosphere and is no longer propelled, it is now subject to only the force of gravity. The friction forces can generally be neglected. The trajectory of the ballistic missile in unpropelled exoatmospheric phase then depends on the initial position (dᵢ, θᵢ, φᵢ) and on the initial speed (\dot{d}ᵢ, \dot{θ}ᵢ, \dot{φ}ᵢ) of the ballistic missile at the end of propulsion out of the atmosphere, respectively called injection point and speed at injection. The kinematic model can take into account the variability of the gravity, the latter being dependent on the altitude, the latitude and, to a lesser extent, the longitude of the ballistic missile. Consequently, the step 105 for determining the trajectory of the ballistic missile consists in determining the distances dₜ that enable the positions in three dimensions (dₜ, θₜ, φₜ) of the missile to satisfy non-braked ballistic trajectory equations.

According to a particular embodiment, the step 105 is repeated each time a new pair of angles (θₜ, φₜ) is determined. A global optimization method, such as the non-linear least squares method, can thus be applied to the positions in three dimensions (dₜ, θₜ, φₜ) of the missile in order to refine these positions.

According to a particular embodiment, the step 105 comprises two substeps. A first substep determines the positions in three dimensions (dₜ, θₜ, φₜ) of the missile that make it possible to satisfy non-braked ballistic trajectory equations given constant gravity. In a second substep, the positions in three dimensions (dₜ, θₜ, φₜ) of the missile are refined by considering non-braked ballistic trajectory equations with variable gravity. The first kinematic model used, with constant gravity, makes it possible to determine, roughly but quickly, the trajectory of the ballistic missile. The second kinematic model used, with variable gravity, makes it possible to refine the trajectory from the first estimated trajectory.

In the case where the passive sensor supplying coordinates representative of an azimuth angle and of an elevation angle of the ballistic missile is located at ground level or in the bottom layers of the atmosphere, and is tracking a missile that is low on the horizon, the ballistic missile is observed through the bottom layers of the atmosphere. Now, these layers generate a deflection of the electromagnetic radiation through refraction effect. Consequently, the azimuth θₜ and elevation φₜ angles determined during the step 104 are different from the real azimuth and elevation angles. The azimuth θₜ and elevation φₜ angles can be corrected by applying a corrective factor to them. The corrective factor applied to an azimuth angle θₜ or to an elevation angle φₜ may notably depend on the azimuth θₜ and elevation φₜ angles themselves, on the distance dₜ, on the seasonal conditions and on the atmospheric conditions, according to known laws. The passive sensor may also be embedded in a surveillance aircraft. The ballistic missile can then be observed without passing through the cloudy layers. Furthermore, the airborne solution offers the advantage of reducing the masking due to the roundness of the earth.

FIG. 2 illustrates a second exemplary embodiment of the step 102 for checking that the ballistic missile has reached the unpropelled exoatmospheric flight phase. This step 102 may consist in determining whether the missile is actually following a ballistic trajectory. To this end, in a first step 201, a counter can be initialized with the value N=1. In second and third steps 202 and 203, respectively equivalent to the steps 103 and 104 of the method described with reference to FIG. 1, a pair of angles (θₜ, φₜ) is determined for the position of the ballistic missile at the iteration N. In a fourth step 204, a determination is made as to whether there is a sufficient number of pairs of angles (θₜ, φₜ) available, for example by comparing the value N of the counter to the value of a first threshold N₁. If such is not the case, the steps 202, 203 and 204 are repeated and the value N of the counter is incremented by one unit in a step 205. Conversely, that is to say if there are more than N₁ pairs of angles (θₜ, φₜ) available, a determination is made as to whether the last N₁ pairs of angles determined satisfy non-braked ballistic trajectory equations. If such is not the case, the steps 202 to 206 are repeated and the value N of the counter is initialized with the value of the first threshold N₁ in a step 207. Conversely, that is to say if the last N₁ pairs of angles (θₜ, φₜ) satisfy non-braked ballistic trajectory equations, the value N of the counter is compared to the value of a second threshold N₂ which makes it possible to achieve a sufficient accuracy in the determination of the trajectory. If the value N of the counter is less than or equal to the value of the second threshold N₂, the value N of the counter is incremented by one unit in the step 205 and the steps 202 to 208 are repeated. Otherwise, the step 102 is terminated in a step 209 and the method described with reference to FIG. 1 is continued with the step 103. This second exemplary embodiment of the step 102 offers the advantage, compared to checking the infrared signature of the ballistic missile, of not requiring observation of the missile at the exact moment when its propulsion phase ends.

According to a particular embodiment, the method of determining the trajectory of a ballistic missile according to the invention comprises a step for estimating the point of impact. The point of impact can be estimated by extrapolating the trajectory of the ballistic missile determined in the unpropelled exoatmospheric phase. A ballistic missile generally reaches a range that is specific to the type of missile to which it belongs. Consequently, the method according to the invention may include a step consisting in determining the type of ballistic missile being observed from its trajectory and therefore its range. The knowledge of the type of ballistic missile being observed makes it possible notably to determine its aerodynamic drag coefficient, called ballistic coefficient. Thus, during the step for determining the point of impact, the extrapolation of the trajectory of the ballistic missile may use a kinematic braked ballistic trajectory model for all the positions of the ballistic missile in atmospheric phase. In case of uncertainty as to the type of the missile, several points of impact may be calculated.

The method for determining the trajectory of a ballistic missile according to the invention may also include a step for determining the launch point of the ballistic missile. The launch point can be estimated by extrapolating the trajectory of the ballistic missile determined in the unpropelled exoatmospheric phase. In the same way as for determining the point of impact, the method according to the invention may include a step consisting in determining the type of ballistic missile being observed from its trajectory. Knowing the type of ballistic missile being observed makes it possible not only to determine its ballistic coefficient, but also its propulsion capabilities. The step for determining the launch point may use a kinematic trajectory model taking account of the drag forces and of the propulsion forces. Advantageously, the determination of the launch point also takes into account the pairs of angles (θₜ, φₜ) determined by the passive sensor before the injection point.

1. A method for determining the trajectory of a ballistic missile, comprising:
a step for determining, at different instants (t) when the ballistic missile is in unpropelled exoatmospheric phase, an azimuth angle (θₜ) and an elevation angle (φₜ) of the ballistic missile,
a step for determining positions in three dimensions ((dₜ, θₜ, φₜ)) of the ballistic missile at said instants (t) from the various pairs of angles ((θₜ, φₜ)) and from a kinematic non-braked ballistic trajectory model, said step comprising a first substep consisting in determining the positions in three dimensions ((dₜ, θₜ, φₜ)) using a kinematic non-braked ballistic trajectory model with constant gravity, and a second substep consisting in refining the positions in three dimensions ((dₜ, θₜ, φₜ)) using a kinematic non-braked ballistic trajectory model with variable gravity according to the position of the ballistic missile relative to a terrestrial coordinate system.

2. The method according to claim 1, wherein the step for determining a pair of angles ((θₜ, φₜ)) of the ballistic missile comprises a step for determining a pair of coordinates ((αₜ, βₜ)) of the ballistic missile that are representative of an azimuth angle (θₜ) and of an elevation angle ((φₜ) of said ballistic missile, and a step for determining the pair of angles ((θₜ, φₜ)) of the ballistic missile from a relationship linking the pairs of coordinates ((αₜ, βₜ)) to the pairs of angles ((θₜ, φₜ)) of the ballistic missile.

3. The method according to claim 2, wherein the pairs of coordinates ((αₜ, βₜ)) of the ballistic missile are acquired by a high-resolution camera, the coordinates ((αₜ, βₜ)) of the ballistic missile being defined in a coordinate system linked to the high-resolution camera.

4. The method according to claim 1, wherein the step for determining positions in three dimensions ((dₜ, θₜ, φₜ)) of the ballistic missile is repeated on each determination of a new pair of angles ((θₜ, φₜ)), the positions in three dimensions ((dₜ, θₜ, φₜ)) of the ballistic missile being refined by the non-linear least squares method.

5. The method according to claim 1, further comprising:
a step for estimating the point of impact of the ballistic missile from its positions in three dimensions ((dₜ, θₜ, φₜ)) in unpropelled exoatmospheric phase and from a kinematic braked ballistic trajectory model in atmospheric phase.

6. The method according to claim 5, wherein the step for estimating the point of impact of the ballistic missile comprises a preliminary step for determining the type of the ballistic missile from its trajectory in unpropelled exoatmospheric phase and from its range, the kinematic braked ballistic trajectory model using a ballistic coefficient that is a function of the type of the ballistic missile.

7. The method according to claim 1, further comprising:
a step for estimating the launch point of the ballistic missile from its positions in three dimensions ((dₜ, θₜ, φₜ)) in unpropelled exoatmospheric phase and from a kinematic braked ballistic trajectory model in atmospheric phase.

8. The method according to claim 7, wherein the step for estimating the launch point of the ballistic missile comprises a preliminary step for determining the type of the ballistic missile from its trajectory in unpropelled exoatmospheric phase and from its range, the kinematic braked ballistic trajectory model using a ballistic coefficient that is a function of the type of the ballistic missile.

9. The method according to claim 1, wherein the step for estimating the launch point of the ballistic missile also takes account of pairs of angles ((θₜ, φₜ)) of the ballistic missile determined before the unpropelled exoatmospheric phase.
